(19) United States
(12) Patent Application Publication
(10) Pub. No.: US 2008/0230932 A1
(43) Pub. Date: Sep. 25, 2008

(54) MOLDING APPARATUS AND MOLDING METHOD FOR OPTICAL ELEMENTS

(75) Inventor: Shinji TANAKA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 12/129,045

(22) Filed: May 29, 2008

Related U.S. Application Data
(63) Continuation of application No. PCT/JP2006/323839, filed on Nov. 29, 2006.

(30) Foreign Application Priority Data
Dec. 2, 2005 (JP) 2005-348606

(51) Int. Cl. B29D 11/00

(52) U.S. Cl. 264/1.1; 425/338

(57) ABSTRACT

There is provided a molding apparatus and a molding method for optical elements, which are capable of conveying respective molds to respective correct positions.

In a molding apparatus for optical elements, comprising a heating section, a press-molding section and a cooling section on a conveying path, a plurality of successive molds being simultaneously slid and conveyed on the conveying path in a conveying direction, and comprising conveying arms for pushing rear sides of the respective molds in the conveying direction to move the molds forward, the conveying arms pushing the rear sides of the respective molds at front sides thereof to transfer the respective molds by a distance; each of the conveying arms has a positioning recessed portion formed at a rear part thereof, whereby each of the conveying arms is moved backward to correct the position of the mold therebehind after having transferred the molds by such a distance.

### TECHNICAL FIELD

The present invention relates to a molding apparatus for press-molding optical elements, such as high-precision glass lenses, to be used for optical instruments, and a molding method using the molding apparatus.

### BACKGROUND ART

Heretofore, a molding method has been widely implemented for producing an optical element comprising a glass lens by press-molding a heated and softened glass material. Specifically, a glass material, which has been preliminarily molded into, e.g., a spherical shape, is set in a mold comprising a top mold, a bottom mold and a body mold, the glass material is softened by being heated to a temperature of about 500 to about 700° C. in a heating step, the softened glass material is pressurized to be molded into a lens product and is cooled, followed by being taken as a final product out of the mold. Each of these steps is carried out in a chamber with a non-oxidizing atmosphere kept therein and without oxygen contained therein, to prevent oxidation of, in particular, the heated mold. The glass material in the mold is sequentially conveyed to heating, press-molding and cooling sections arranged on a linear or a circular conveying path.

In such a molding apparatus, the following conveying method has been proposed as a method for conveying a mold.

FIG. 9 shows an example of the conventional conveying methods, wherein molds 5 are conveyed by a comb-like bar 9. FIG. 9(A) is a plan view, and FIG. 9(B) is a vertical cross-sectional view. Such a molding apparatus has been disclosed in, e.g., patent document 1.

In a case where the comb-like bar 9 is utilized to push and slide a mold 5, when the bar 9 is brought into contact with the mold 5, the bar 9 is deformed by heat transferred from the mold being heated, in some cases.

FIG. 10 is a plan view showing the sliding direction of the mold 5 when the bar 9 has been deformed. If the bar 9 has been deformed as indicated by two-dot chain lines, the contact plane of the bar 9 with the mold 5 is deflected, with the result that the mold 5 is pushed in a direction “e” deviated from a desired conveying direction “d”. When the mold 5 is sequentially conveyed into respective sections for heating, press-molding and cooling after the mold is put on a conveying path, having its conveying direction deviated, the positional displacement of the mold 5 increases, causing the mold to protrude from the conveying path in some cases. The occurrence of a fabrication error also causes positional displacement of the mold 5 in a similar way.

In order to avoid the occurrence of such positional displacement, patent document 2 has proposed a molding apparatus, which comprises a grooved guiding member for moving a mold in a correct conveying direction. Specifically, a mold is fitted into the grooved member having a width in conformity of the mold, and the mold is conveyed, being pushed by a bar with a swingable pressing arm.

This arrangement can prevent the conveying direction of such a mold from being deviated since the grooved member guides the mold in the correct conveying direction. However, since there is no measure for aligning the center of such a mold with the center of, e.g., a heating or cooling member, both centers fail to be aligned with each other, with the result that the temperature distribution in the mold is made nonuniform in some cases after the conveyance of the mold has started. Accordingly, the temperature distribution transferred to a glass material through the mold is made asymmetric, failing to mold, with sufficient precision, a lens, in some cases, which is required to have a symmetrical shape and symmetrical characteristics.

Furthermore, since it is necessary to use a grooved member matched with the outer size of a mold, grooved members are required to be exchanged in order to convey molds having different outer sizes, which takes a lot of time and bears the expense of the grooved members.

In order to solve the above-mentioned problems, it is necessary to provide a means for correctly positioning a mold after the start of conveyance. However, the provision of such a positioning device increases not only the size of the entire molding apparatus but also the cost. Further, it is difficult to increase the durability of the positioning device since the molding apparatus is at a high temperature therein.

When the positioning device is provided independently from the conveying unit; in order to avoid interference between the positioning device and the conveying unit, the positioning device needs to be activated after the conveying unit is retracted, which increases the entire molding time.

Patent document 3 discloses an apparatus, which when a plurality of molds are simultaneously conveyed, a conveying jig, which has recessed portions formed therein for positioning molds in order to convey the respective molds in a correct position, is used to convey the molds, having the molds fitted into the recessed portions. This apparatus can convey the molds in a correct position without separately providing a positioning device, since the conveying jig also serves as a positioning means.

However, the molds are thermally expanded when the molds are heated. In order to position the molds by fitting the molds at their outer sides into the recessed portions, the outer dimensions of the molds that have been thermally expanded need to be correctly unified, which requires to carry out strict dimensional control.

When heated molds are conveyed, being fitted into the conveying jig, the temperature distribution in each of the molds is made nonuniform since there is a temperature difference between each of the molds and the conveying jig. When the molds are constantly brought into the conveying jig, no temperature difference is caused. However, since the molds and the conveying jig serve as members to be heated (or cooled) in both of heating and cooling steps, the heat capacity is increased to require unnecessary heating and cooling, with the result that some quantity of heat is uselessly wasted.

Patent document 1: JP-B-8-13687

Patent document 2: JP-B-3-55417

Patent document 3: Japanese Patent No. 2785683

### DISCLOSURE OF THE INVENTION

### Problems to be Solved by the Invention

The present invention has been proposed, taking the above-mentioned prior art into account. It is an object of the present invention to provide a molding apparatus and a molding method for optical elements, which are capable of conveying respective molds to respective correct positions.

### Means for Solving the Problems

The present invention provides a molding apparatus for optical elements, comprising a heating section, a press-molding section and a cooling section on a conveying path, a plurality of molds, which are successively arrayed in a conveying direction, being simultaneously slid and conveyed on the conveying path, and comprising conveying arms for pushing rear sides of the respective molds in the conveying direction to move the molds forward, the conveying arms pushing the rear sides of the respective molds at front sides thereof to transfer the respective molds by a distance; further comprising positioning means, each of the positioning means having a positioning recessed portion formed therein to correct the position of a mold therebehind after the conveying arms have conveyed the molds by such a distance (hereinbelow, referred to as the molding apparatus according to the present invention).

In the molding apparatus according to the present invention, it is preferred that each of the conveying arms have the recessed portion integrally formed at a rear part thereof as the positioning means.

It is preferred that the molding apparatus according to the present invention further comprise positioning arms as the positioning means, the positioning arms being configured so as to be separate from the conveying arms and having the recessed portion formed therein.

In the molding apparatus according to the present invention, it is preferred that the front part and the rear part of each of the conveying arms be thermally separated from each other.

In the molding apparatus according to the present invention, it is preferred that the recessed portion comprise opposing tapered edges or an arc edge.

In the molding apparatus according to the present invention, it is preferred that the plurality of conveying arms be coupled at end portions thereof.

In the molding apparatus according to the present invention, it is preferred that the respective conveying arms simultaneously push plural molds by the front parts thereof.

The present invention also provides a molding method for optical elements, which uses the molding apparatus according to the present invention, and which comprises simultaneously sliding and transferring a plurality of molds on a conveying path along a conveying direction by a distance, each of the molds comprising a top mold, a bottom mold and a body mold, and sequentially carrying out a heating step, a press-molding step and a cooling step on the conveying path after having transferred the molds; further comprising correcting the positions of the molds to position the molds by the recessed portions after having transferred the molds (hereinbelow, referred to as the molding method according to the present invention).

It is preferred that the molding method according to the present invention further comprise separating the conveying arms from the molds immediately after having completed positioning operation for the molds.

### EFFECTS OF THE INVENTION

In accordance with the present invention, each of the positioning recessed portions, which correct the position of a mold therebehind, may be formed on a rear side of each of the conveying arms for transferring molds, being integral with or separated from each of the conveying arms. When each of the recessed portions is retracted after conveyance, the mold can be corrected in terms of positional displacement to be put at a correct position. By this arrangement, the respective steps can be carried out at accurate positions under accurate temperature distribution conditions, making it possible to obtain press-molded products having high precision in terms of geometrical dimensions and optical characteristics.

In accordance with the present invention, each of the positioning recessed portions, which correct the position of a mold therebehind, may be integrally formed in, in particular, a rear part of each of the conveying arms. This arrangement has no need for providing a positioning device independently from the conveying device and has a simple structure. As a result, it is possible to prevent the molding apparatus from being made larger and the cost from increasing. By exchanging only conveying arms of an existing molding apparatus, it is possible to use the existing molding apparatus as it is.

In accordance with the present invention, the positioning arms may be additionally disposed in an existing molding apparatus, being independent from the conveying arms of the existing molding apparatus while using the conveying arms without modification. This arrangement can interlock the positioning arms with the conveying arms by a simple system or mere coupling, with the result that a required positioning means can be realized without a substantial change in equipment.

In accordance with the present invention, the front part and the rear part of each of the conveying arms may be thermally separated from each other. This arrangement can prevent the position rear part from being adversely affected even if the front part for pressing a mold is thermally deformed. As a result, it is possible to correctly position a mold behind the rear part.

In accordance with the present invention, each of the recessed portions may comprise opposed tapering edges or an arc edge. This arrangement can position the molds by a simple form, irrespective of the size of the molds.

In accordance with the present invention, the plurality of conveying arms may be coupled at end portions thereof. This arrangement can simultaneously make the conveyance and the positional corrections of the plurality of molds by a common power source.

In accordance with the present invention, the respective conveying arms may simultaneously push plural molds by the front parts thereof. This arrangement can effectively make the conveyance and the positional corrections of these molds when these molds are simultaneously subjected to a single step.

In accordance with the present invention, each of the recessed portions corrects the position of each of the molds to position each of the molds after each of the molds has been transferred by each of the conveying arms as stated above. This arrangement can not only effectively convey the molds but also position the molds without taking a lot of time. It is possible not only to successively and smoothly carry out a series of positioning operation but also carry out the respective steps with the molds being set in correct positions since the positional corrections are made after conveyance of the molds.

In accordance with the present invention, the conveying arms may be separated from the molds immediately after having completed positioning operation for the molds. This arrangement can minimize the transfer of heat between each mold and each conveying arm. Accordingly, it is possible to prevent thermal uniformity from being caused in the molds, with the result that the respective steps can be correctly carried out under optimum temperature distributions. It is also possible to prevent the conveying arms from being deformed by the heat of the molds, with the result that the molds can be correctly positioned and that the durability of the conveying arms is increased.

### BRIEF DESCRIPTION OF THE DRAWINGS

FIG. 1 contains schematic views showing an embodiment of the present invention, wherein view (A) is a plan view, and view (B) is a vertical cross-sectional view;

FIG. 2 contains schematic views showing the implementing procedure according to the embodiment shown in FIG. 1;

FIG. 3 contains schematic views showing the implementing procedure following the one shown in FIG. 2;

FIG. 4 contains schematic views showing a different embodiment of the present invention;

FIG. 5 contains schematic views showing another different embodiment of the present invention;

FIG. 6 contains schematic views showing another different embodiment of the present invention;

FIG. 7 is a plan view showing another different embodiment of the present invention;

FIG. 8 contains schematic views showing another different embodiment of the present invention;

FIG. 9 contains schematic views showing prior art; and

FIG. 10 is a schematic view showing what problem the prior art shown in FIG. 9 has.

### EXPLANATION OF NUMERALS

1. molding apparatus, 2: conveying path, 3: material, 4: molded product, 5, 5a, 5b, 5c and 5d: mold, 6, 6a, 6b and 6c: conveying arm, 7: coupling member, 8: conveying jig, 9: bar, 11: introduction section, 12: heating section, 13: press-molding section, 14: cooling section, 15: discharge section, 22: heating plate, 23: molding plate, 24: cooling plate, 51: top mold, 52: bottom mold, 53: body mold, 61, 61a and 61c: front part, 62, 62a and 62c: groove, 63, 63a, 63c: rear part, 64, 64a, 64b and 64c: recessed portion, 70: positioning arm, 71: recessed portion

### BEST MODE FOR CARRYING OUT THE INVENTION

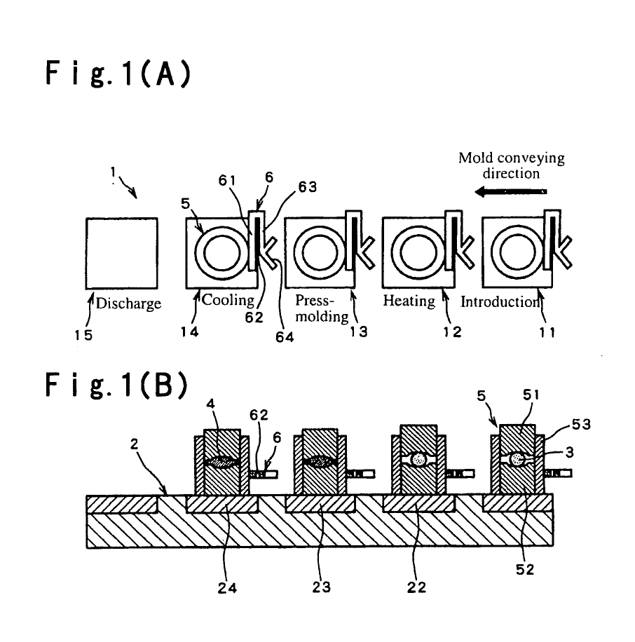

FIG. 1 contains schematic views showing an embodiment of the present invention, wherein view (A) is a plan view, and view (B) is a vertical cross-sectional view.

A molding apparatus 1 is housed in a chamber with a non-oxidizing atmosphere, such as a nitrogen atmosphere, kept therein, and includes a linear conveying path 2, which conveys molds in the direction indicated by the arrow, from the right to the left in this figure.

The conveying path 2 includes an introduction section 11 for introducing a mold with a material set therein, a heating section 12, a press-molding section 13, a cooling section 14, and a discharge section for a product 15 in this order from the right side in this figure. The heating section 12, the press-molding section 13 and the cooling section 14 have a heating plate 22, a molding plate 23 and a cooling plate 24 disposed therein, respectively, so as to be spaced from an adjacent one in order to avoid thermal interference. Although not shown, a heating plate, a molding plate and a cooling plate are also disposed in an upper side, and these plates are vertically moved to implement the respective steps of heating, press-molding and cooling.

Each of the molds 5 comprises a cylindrical body mold 53, a bottom mold 52 fitted into the body mold 53, and a top mold 51 slidable in the body mold 53. The lower surface of the top mold 51 and the upper surface of the bottom mold 52 serve as molding surfaces, between which a material 3 is disposed and pressed to be molded into a molded product 4 as an optical element.

Each of conveying arms 6 comprises a front part 61 formed in a bar-like shape and extending in a direction orthogonal to the conveying direction, and a rear part 63 coupled to a base portion of the front part 61 and extending so as to be opposite the front part 61 with a groove 62 interposed between both parts. The rear part 63 has a leading edge formed with a recessed portion 64, which is forked so as to have a V-letter tapered shape. The front part 61 pushes the mold 5 ahead thereof in the conveying direction and conveys the mold. After having conveyed that mold, the recessed portion 64 of the rear part 61 corrects the position of the mold 5 therebehind.

The groove 62 is formed to thermally separate the front part 61 and the rear part 63. The front part 61 is likely to be deformed by heat from the mold 5 since the front part is brought into contact with the mold 5 all the time during conveyance. Even if the front part 61 is thermally deformed, the provision of the groove 62 between the front part and the rear part 63 can prevent the rear part 63 from being thermally deformed, with the result that the position and the direction of the recessed portion 64 can be correctly kept. It should be noted that the means for thermally separating the front part 61 and the rear part 63 is not limited to the groove 62, and that the front part 61 and the rear part 63 may have an insulating material disposed therebetween.

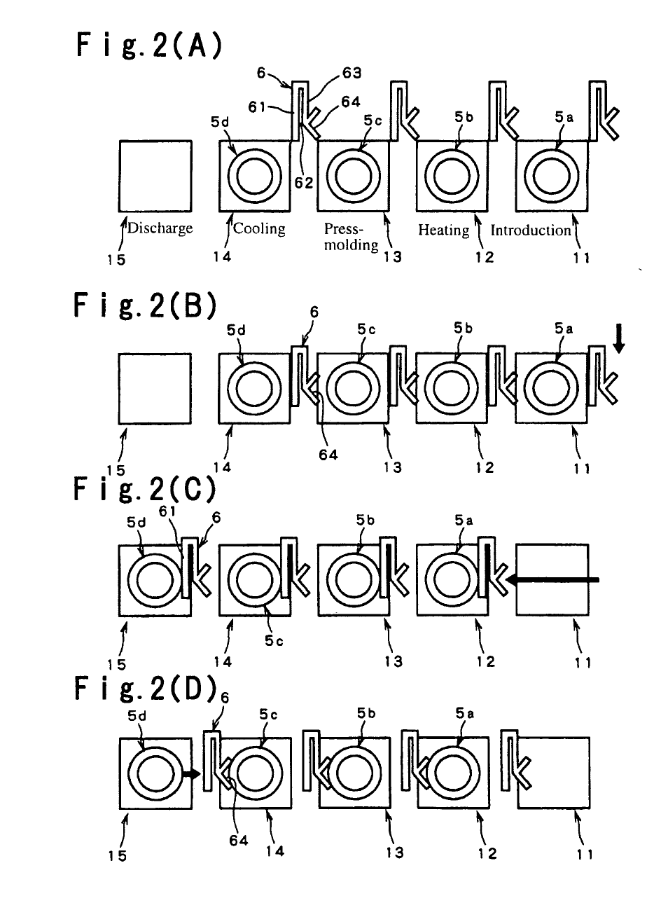

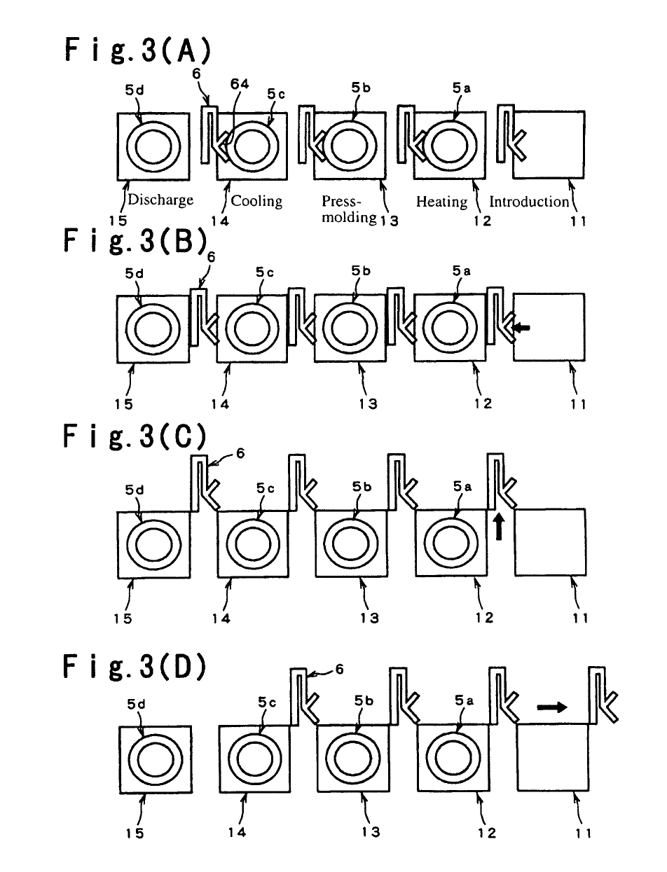

FIG. 2 and FIG. 3 are schematic views showing conveyance of molds 5 and positional procedure for the molds.

FIG. 2(A) shows a state where molds 5a, 5b, 5c and 5d are put in the introduction section 11, the heating section 12, the press-molding section 13 and the cooling section 14, respectively, in this order from the right in this figure. The mold 5a in the introduction section 11 has a material of a glass bead set therein. The mold 5b in the heating section 12 is subjected to a heating step for heating the mold 5b to such a temperature that the material therein is softened to be capable of being press-molded. The mold 5c in the press-molding section 13 is subjected to a molding step for press-molding the material therein to a molded product having desired dimensions. The mold 5d in the cooling section 14 is subjected to a cooling step for cooling the mold to such a proper temperature that the quality of the molded product can be stabilized.

While these steps are performed, the conveying arms 6 are placed in standby positions apart from the molds as shown in FIG. 2(A). After these steps have been completed, the conveying arms 6 move in a downward direction in this figure so as to have centers of the respective recessed portions 64 aligned with the centers of the respective mold positions (the center in a direction orthogonal to the conveying direction) in the conveying direction as shown in FIG. 2(B).

Next, as shown in FIG. 2 (C), the conveying arms 6 move in the left direction in this figure, and the front sides of the front parts 61 of the conveying arms 6 are brought into contact with the rear sides of the respective molds 5a, 5b, 5c and 5d to push and move the respective molds from one section to the next section in the left direction.

When the respective molds 5a, 5b, 5c and 5d have been conveyed to the respective next steps, i.e., to the heating section 12, the press-molding section 13, the cooling section 14 and the discharge section 15, respectively, the conveying arms 6 immediately move in the right direction in this figure, and the recessed portions 64 of the respective rear parts 63 are brought into contact with the front sides of the molds 5a, 5b, and 5c therebehind seen from the conveying direction as shown in FIG. 2(D). Since the recessed portions 64 are formed in a tapered shape, the respective molds 5a, 5b and 5c, each of which is formed in a cylindrical shape, are engaged with the recessed portions 64, respectively, and the respective molds 5a, 5b and 5c are positioned, being guided by the respective tapered portions. In this way, the molds 5a, 5b and 5c can be put in correct positions and be molded as fine molded products, being symmetrically subjected to heat treatment in the heating section 12 and the cooling section 14, and being symmetrically and uniformly pressed in the press-molding section 13. The mold 5d, which has been conveyed to the discharge section 15, does not need to be corrected in terms of position since no subsequent processing step is performed.

FIG. 3(A) shows the same state as FIG. 2(D), where the molds 5a, 5b, 5c and 5d are put in the heating section 12, the press-molding section 13, the cooling section 14 and the discharge section 15, respectively, and where the molds 5a, 5b and 5c are positioned by the recessed portions 64 of the conveying arms 6, respectively.

When the mold 5a, 5b and 5c have been positioned, the conveying arms 6 immediately move to positions having no contact with the molds by a small distance in the left direction as shown in FIG. 3(B). Then, the conveying arms move to positions apart from the molds in an upper direction in this figure as shown in FIG. 3(C). After that, the conveying arms 6 move in the right direction in this figure, and return to the same positions as the ones shown in FIG. 2(A), as shown in FIG. 3(D). Since the time period when the recessed portions 64 are brought into contact with molds is made as short as possible by separating the conveying arms 6 from the molds immediately after positioning, the asymmetric thermal state in the molds can be minimized, and the recessed portions 64 can be prevented from being thermally deformed.

In this state, the mold 5a in the heating section 12 is subjected to the heating step, the mold 5b in the press-molding section 13 is subjected to the molding step, and the mold 5c in the cooling section is subjected to the cooling step, while the mold 5d in the discharge section 15 is taken off its top mold, followed by taking out a completed molded product, which has been completely subjected to the above-mentioned series of production steps. On the other hand, a mold with a material set therein is newly put in the introduction section 11, taking the state shown in FIG. 2(A). In this way, the steps shown in FIG. 2 and FIG. 3 are repeated.

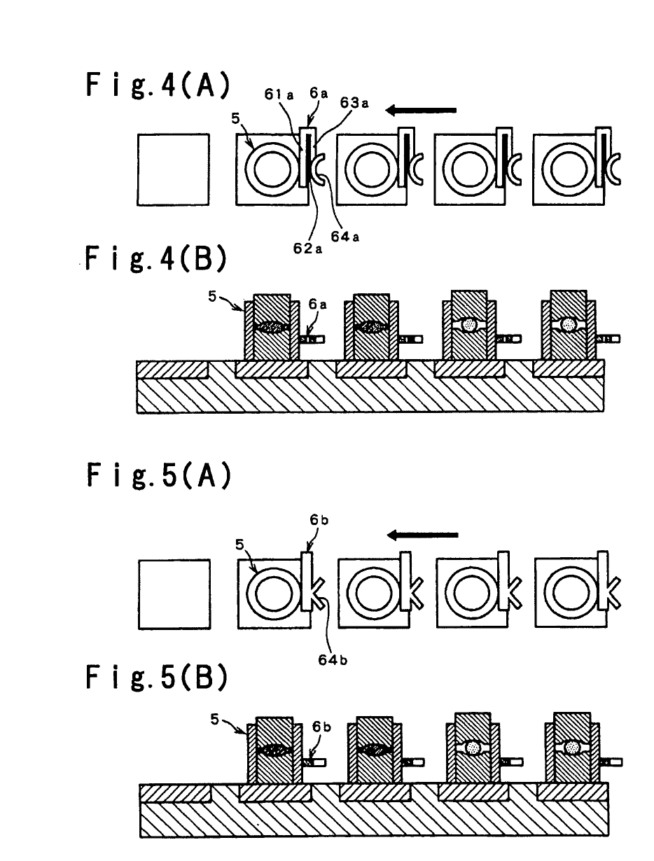

FIG. 4 shows a different embodiment of the present invention, wherein view (A) is a plan view, and view (B) is a cross-sectional view. In this embodiment, the recessed portion for positional correction, which is formed in the rear part of each of the conveying arms, is modified to be formed in a circular shape instead of a V-letter shape.

As in the embodiment shown in FIG. 1, each of the conveying arms 6a comprises a front part 61a formed in a bar-like shape and extending in a direction orthogonal to the conveying direction, and a rear part 63a coupled to a base portion of the front part 61a and extending so as to be opposite the front part 61a with a groove 62a interposed between both parts. The rear part 63a has a leading edge formed with a recessed portion 64a, which is formed in a circular shape. The conveyance and the positional correction procedure by each of the conveying arms 6a are carried out in the same way as the above-mentioned embodiment.

FIG. 5 shows another different embodiment of the present invention, wherein view (A) is a plan view, and view (B) is a cross-sectional view.

Each conveying arm 6b is integrally configured without being separated into a front part and a rear part, and each conveying arm has a recessed portion 64b formed so as to have a V-letter taper in a rear side seen from the conveying direction. This embodiment can be implemented in such a state that each conveying arm 6b is unlikely to be thermally deformed, since the time period when each conveying arm 6b is brought into contact with each mold 5 during conveyance and positioning is significantly reduced. The conveyance and the positional correction procedure by each conveying arm 6b are carried out in the same way as the embodiment shown in FIG. 2 and FIG. 3.

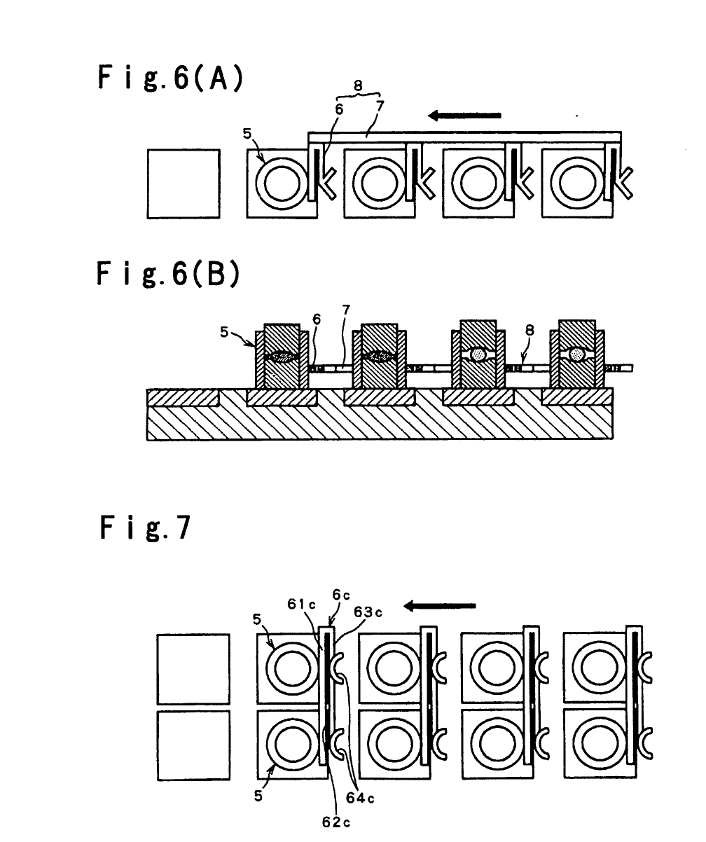

FIG. 6 shows another different embodiment of the present invention, wherein view (A) is a plan view, and view (B) is a cross-sectional view.

Conveying arms 6, which are formed in the same way as the embodiment shown in FIG. 1, are disposed so as to be orthogonal to the conveying direction and to be conformed as a conveying jig 8, being coupled together at end portions of the conveying arms by a coupling member 7. When this conveying jig 8 is used, it is possible to simultaneously move the plurality of conveying arms 6 by a common driving source. It should be noted that the conveying arms may be formed in the same shape as the conveying arms 6a shown in FIG. 4 or the conveying arms 6b shown in FIG. 5.

FIG. 7 is a plan view showing another different embodiment of the present invention.

The molds 5 are disposed in pairs so as to be orthogonal to the conveying direction, being sequentially arrayed in two lines as a whole. This embodiment is implemented when paired molds are simultaneously subjected to the respective steps of the heating, press-molding and cooling steps. Each conveying arm 6c has such a length that the front side 61c of each conveying arm can push the rear sides of both molds 5 and 5 arrayed at two lines, and paired molds in each step are simultaneously conveyed. Each conveying arm has a rear side 63c formed with recessed portions 64c and 64c in conformity with the respective centers of molds 5 and 5 arrayed in two lines therebehind. By this arrangement, the positions of the molds arrayed behind in two lines are simultaneously corrected.

Even if the molds are arrayed in three or more lines, the present invention may be carried out in a similar way by increasing the length of each conveying arm and forming recessed portions in conformity with the centers of the arrayed molds. When the length of the front part of each conveying arm, which pushes molds, is increased as stated above, it is preferred in consideration of an increase in the displacement of the leading edge caused even by slight thermal deformation that the front part 61c and the rear part 63c have a groove 62c formed therebetween in order to thermally separate both parts 61c and 63c.

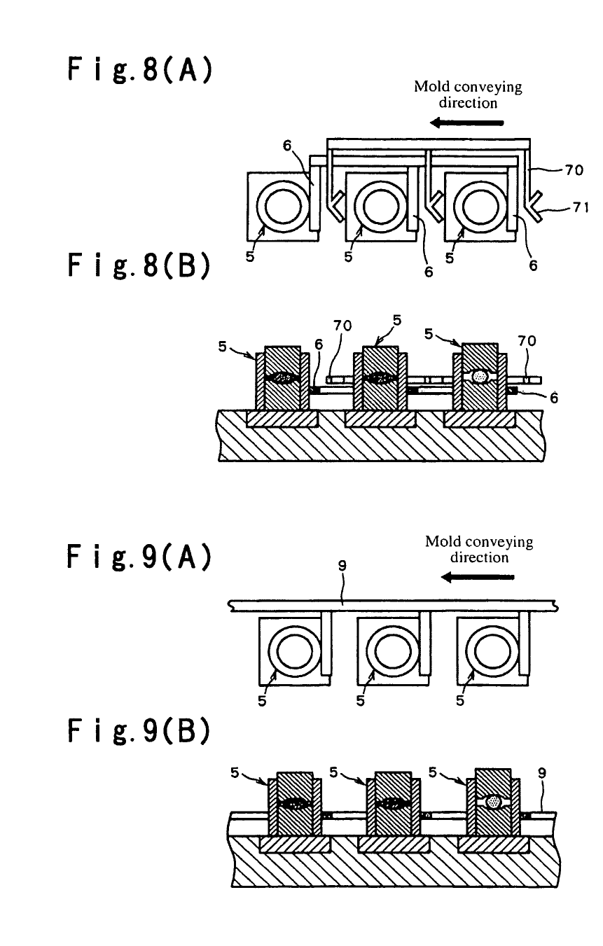

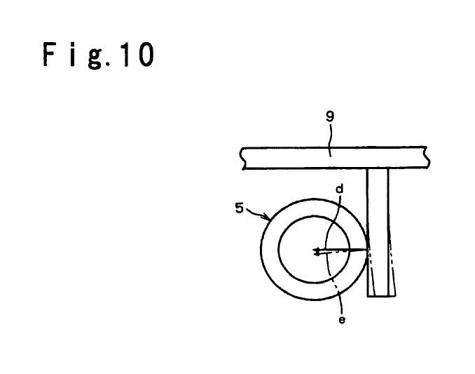

FIG. 8 is a schematic configuration view of another embodiment of the present invention. View (A) is a plan view and view (B) is a front view.

In this embodiment, each of positioning arms 70 is disposed behind each of the conveying arms 6, being separated from each of the conveying arms 6 for moving molds 5, and each of the positioning arms 70 is provided with a positioning recessed portion 71. The conveying arms 6 are coupled together while the positioning arms 70 are coupled together. The positioning arms 70 may be coupled to a driving unit (not shown) for the conveying arms 6. Or, the positioning arms 70 may be coupled and fixed to the conveying arms 6. The operation for positioning a trailing mold, which is made by the recessed portion 71 of each positioning arm 70, is made in the same way as the above-mentioned embodiments.

Although the above-mentioned embodiments have been described about a case where the molding apparatus includes the conveying path 2 in a linear shape and implements different steps in the respective sections, the present invention may be implemented even in a different case, e.g., where the apparatus includes a conveying path comprising a forward path and a return path.

### INDUSTRIAL APPLICABILITY

The present invention is applicable to an apparatus for producing molded products, which comprises heating, molding and cooling steps.

The entire disclosure of Japanese Patent Application No. 2005-348606 filed on Dec. 2, 2005 including specification, claims, drawings and summary is incorporated herein by reference in its entirety.

What is claimed is:

1. A molding apparatus for optical elements, comprising a heating section, a press-molding section and a cooling section on a conveying path, a plurality of molds, which are successively arrayed in a conveying direction, being simultaneously slid and conveyed on the conveying path, and comprising conveying arms for pushing rear sides of the respective molds in the conveying direction to move the molds forward, the conveying arms pushing the rear sides of the respective molds at front sides thereof to transfer the respective molds by a distance;
further comprising positioning means, each of the positioning means having a positioning recessed portion formed therein to correct the position of a mold therebehind after the conveying arms have conveyed the molds by such a distance.

2. The molding apparatus according to claim 1, wherein each of the conveying arms has the recessed portion integrally formed at a rear part thereof as the positioning means.

3. The molding apparatus according to claim 1, further comprising positioning arms as the positioning means, the positioning arms being configured so as to be separate from the conveying arms and having the recessed portion formed therein.

4. The molding apparatus according to claim 2, wherein the front part and the rear part of each of the conveying arms are thermally separated from each other.

5. The molding apparatus according to claim 1, wherein the recessed portion comprises opposed tapering edges or an arc edge.

6. The molding apparatus according to claim 1, wherein the plurality of conveying arms are coupled at end portions thereof.

7. The molding apparatus according to claim 1, wherein the respective conveying arms push plural molds by the front parts thereof.

8. A molding method for optical elements, which uses the molding apparatus defined in claim 1, and which comprises simultaneously sliding and transferring a plurality of molds on a conveying path along a conveying direction by a distance, each of the molds comprising a top mold, a bottom mold and a body mold, and sequentially carrying out a heating step, a press-molding step and a cooling step on the conveying path after having transferred the molds,
further comprising correcting the positions of the molds to position the molds by the recessed portions after having transferred the molds.

9. The molding method according to claim 8, further comprising separating the conveying arms from the molds immediately after having completed positioning operation for the molds.
